(19) United States
(12) Patent Application Publication
(10) Pub. No.: US 2005/0195917 A1
(43) Pub. Date: Sep. 8, 2005

(54) Method and apparatus for crystal drift compensation

(75) Inventors: Robert B. Staszewski, Garland, TX (US); Dirk Leipold, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/883,501

(22) Filed: Jun. 30, 2004

Related U.S. Application Data
(60) Provisional application No. 60/550,919, filed on Mar. 5, 2004.

(51) Int. Cl. H04L 27/04

(52) U.S. Cl. 375/295

(57) ABSTRACT

A mobile device includes frequency synthesizer circuitry for generating a channel frequency at a multiple of a reference frequency. The reference frequency is generated by a free-running crystal oscillator, without frequency stabilization circuitry. Variations in the output of the crystal oscillator are compensated by adjusting the multiplication factor of the frequency synthesizer.

### CROSS-REFERENCE TO RELATED APPLICATIONS

This application claims the benefit of the filing date of copending provisional application U.S. Ser. No. 60/550,919 filed Mar. 5, 2004, entitled “Crystal Drift Compensation in a Mobile Phone” to Staszewski et al.

### STATEMENT OF FEDERALLY SPONSORED RESEARCH OR DEVELOPMENT

Not Applicable

### BACKGROUND OF THE INVENTION

1. Technical Field

This invention relates in general to communication circuits and, more particularly, to a method and apparatus for correcting crystal drift in a communication circuit.

2. Description of the Related Art

Many communication devices use a crystal oscillator circuit as a frequency reference. The frequency output of the crystal oscillator circuit is multiplied by a known factor in a frequency synthesizer circuit to obtain a desired channel frequency. Typically, the reference frequency generated by the oscillator is in the range of tens of MHz, while the channel frequency is in the range of multiple GHz.

Many modern day communication standards, in particular cellular standards such as GSM (Global System for Mobile Communications), place stringent standards on the accuracy and stability of the frequency synthesizer circuit. Unfortunately, the output of a crystal oscillator tends to drift slightly with age and temperature. Due to the stringent requirements, it is not possible to use a cost-effective stand-alone crystal oscillator in a cellular system without some frequency tuning support from the basestation.

In a conventional technique, the basestation sends a highly accurate carrier frequency to the mobile device and the mobile device determines deviations in its reference frequency based on the received signal. The frequency deviations are used to adjust the frequency of a digitally controlled crystal oscillator (DCXO). Since the frequency adjustment process may not be accurate enough to obtain a perfect frequency in a single correction, the process could be performed iteratively.

Unfortunately, a DCXO circuit requires large capacitors to perform frequency corrections on the crystal oscillator. Using this technique, therefore, is extremely expensive, particularly for highly-integrated transceivers in a deep-submicron CMOS process. Further, the switching of a large number of capacitors in the DCXO circuit to adjust the reference frequency can result in frequency beating events that exhibit themselves as spurs in the generated output.

Therefore, a need has arisen for a low-cost, low-noise solution for compensating crystal drift.

### BRIEF SUMMARY OF THE INVENTION

In the present invention, a receiver comprises a crystal oscillator for generating a reference signal having a reference frequency and a frequency multiplying circuit for generating an output signal having an output frequency responsive to the reference frequency and a digital frequency command word. The frequency command word is adjusted responsive to a variation between the output frequency and a desired frequency.

The present invention provides significant advantages over the prior art. First, a simple crystal oscillator can be used without complex stabilizing circuitry, which significantly reduces the cost of the circuit. Second, the design eliminates the noise associated with switching large capacitors to stabilize the reference frequency.

In a second embodiment of the present invention, a receiver comprises a crystal oscillator for generating a reference signal having a reference frequency, control circuitry for controlling the reference frequency of the crystal oscillator responsive to a frequency correction signal, and a digitally controlled frequency synthesizer for generating an output signal with an output frequency at a multiple of the reference frequency. The control circuitry is clocked synchronously with edges of the output signal.

The aspect of the invention reduces noise attributable to circuitry used to stabilize the output of a crystal oscillator, where the logic in the control circuitry does not switch synchronously with the output signal.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1a illustrates the operation of a frequency synthesizer;

FIG. 1b illustrates a block diagram of an all-digital phase-locked loop (ADPLL) based transmitter;

FIG. 2a illustrates a block diagram of a transmitter of the type shown in FIG. 1b, using a variable multiplier to compensate for variations in the reference frequency provided by a free-running crystal oscillator;

FIG. 2b illustrates a transmitter of the type shown in FIG. 2a with a pulse shaping filter responsive to a divided output clock signal;

FIG. 2c illustrates a transmitter of the type shown in FIG. 2a using a coarsely-adjustable time base for generating a reference signal;

FIG. 2d illustrates a base station providing a high quality reference signal for use in adjusting the frequency synthesizer output of a mobile device;

FIGS. 3a and 3b illustrates injection pulling due to separation between clock edges;

FIG. 3c illustrates a block diagram of a transmitter using a reference clock with encoding and ΣΔ modulator logic for fine tuning, where the logic is clocked responsive to the internally generated clock signal;

FIG. 3d illustrates a block diagram of a transmitter using a reference clock with encoding and ΣΔ modulator logic for fine tuning, where the logic is clocked responsive to a clock signal retimed to the output of a frequency synthesizer;

FIG. 3e is a flow chart describing the operation of the circuit of FIG. 3d;

FIG. 4 is a block diagram of an improved retiming, accumulating and sampling circuit.

### DETAILED DESCRIPTION OF THE INVENTION

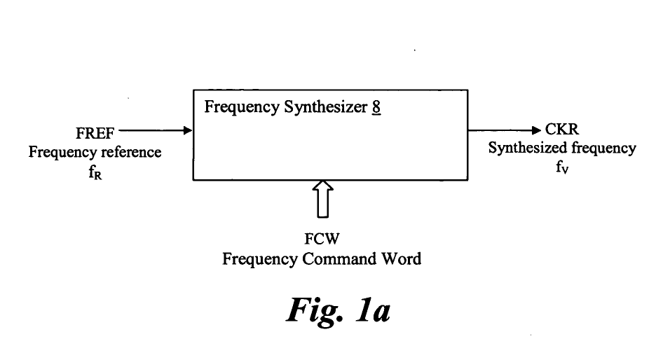

The present invention is best understood in relation to FIGS. 1-4 of the drawings, like numerals being used for like elements of the various drawings.

FIG. 1a illustrates the general operation of a frequency synthesizer 8. RF frequency synthesizer 8 is used as a local oscillator (LO) that performs frequency translation in wireless transmitters and receivers. The frequency reference (FREF) clock at frequency f_{R} contains the only reference timing information for the frequency synthesizer to which the phase and frequency of the RF output are to be synchronized. The RF output CKV at variable frequency (f_{V}) is related to the reference frequency (f_{R}) according to the following formula: f_{V}=N×f_{R}, where, N=FCW is a fractional frequency division ratio.

FIG. 1b illustrates a block diagram of an RF transmitter 10 based on an all-digital phase-locked loop (ADPLL) frequency synthesizer with a digital direct frequency modulation capability. This circuit is described in detail in U.S. Ser. No. 10/131,523, entitled “Digital Phase Locked Loop”, to Staszewski et al, filed Dec. 19, 2002, which is incorporated by reference herein. The RF transmitter 10 features digital design and circuit techniques throughout. At the heart of the transmitter 10 lies a digitally-controlled oscillator (DCO) 12, which deliberately avoids any analog tuning voltage controls. This allows for its loop control circuitry to be implemented in a fully digital manner.

The DCO 12 produces a digital variable clock (CKV) in the RF frequency band. In the feedforward path, the CKV clock toggles NMOS transistor switches of the near-class-E digitally-controlled RF power amplifier (PA or DPA) 14 that is followed by a matching network, and then terminated with an antenna (not shown). In the feedback path, the CKV clock is used for phase detection and reference retiming.

The channel and data frequency command words are in the frequency command word (FCW) format, defined as the fractional frequency division ratio N with a fine frequency resolution limited only by the FCW wordlength. With 24 fractional FCW bits, the frequency granularity is 26 MHz/2²⁴=1.55 Hz, using the 26 MHz reference frequency.

In operation, the ADPLL operates in a digitally-synchronous fixed-point phase domain. The variable phase R_{V}[i] is determined by counting the number of rising clock transitions of the DCO oscillator clock CKV in accumulator 16. The frequency reference signal, FREF, is retimed to CKV in retiming circuit 17 to generate the retimed signal CKR. The reference phase R_{R}[k] is obtained by accumulating FCW with every cycle CKR clock input in accumulator 18. The sampled variable phase R_{V}[k] stored at latch 20 is subtracted from the reference phase in a synchronous arithmetic phase detector 22. The digital phase error φ_{E}[k] is filtered by a digital loop filter 24 and then normalized by the DCO gain K_{DCO} in normalization circuit 26 in order to correct the DCO phase/frequency in the negative feedback manner with the loop behavior that is independent from process, voltage and temperature. The FREF retiming quantization error ε[k] is determined by the time-to-digital converter (TDC) 28 and the DCO period normalization multiplier 30. The TDC 28 is built as a simple array of inverter delay elements and flip-flops, which produces time conversion resolution of less than 40 ps in this process.

It should be recognized that the two clock domains, FREF and CKV (high speed variable phase output from the DCO 12, are not entirely synchronous and it is difficult to physically compare the two digital phase values without having to face metastability problems. During the frequency acquisition, their edge relationship is not known and, during the phase lock, the edges will exhibit rotation if the fractional FCW is non-zero. Consequently, the digital-word phase comparison is performed in the same clock domain. The synchronous operation is achieved by over-sampling the FREF clock by the high-rate DCO clock. The resulting retimed CKR clock is thus stripped of the FREF timing information and is used throughout the system. This ensures that the massive digital logic is clocked after the quiet interval of the phase error detection by the TDC.

A chief advantage of keeping the phase information in fixed-point digital numbers is that, after the conversion, it cannot be further corrupted by noise. Consequently, the phase detector 22 can be simply realized as an arithmetic subtractor that performs an exact digital operation. Therefore, the number of conversion places is kept at minimum: a single point where the continuously-valued clock edge delay is compared in a TDC 28. It should be emphasized here that it is very advantageous to operate in the phase domain for several reasons. First, the phase detector 22, implemented as a subtractor, is not a conventional correlative multiplier generating reference spurs; the arithmetic subtractor does not introduce any spurs into the loop. Second, the dynamic range of the phase error could be made arbitrarily large simply by increasing wordlength of the phase accumulators 16 and 18. Conventional three-state phase/frequency detectors are typically limited to only ±2π of the compare rate. Third, the phase domain operation is amenable to digital implementations, which is quite opposite to the conventional approach.

Accordingly, by specifying a proper FCW, a channel of any desired frequency can be obtained, with high accuracy due to the fractional error correction. Data, processed through pulse filter 30, is modulated on the channel frequency by adding data values y[k] at adders 32 and 34. However, due to the dependency between CKR and FREF, i.e., f_{V}=FCW*f_{R}, the channel frequency will vary along with variations in the frequency of FREF.

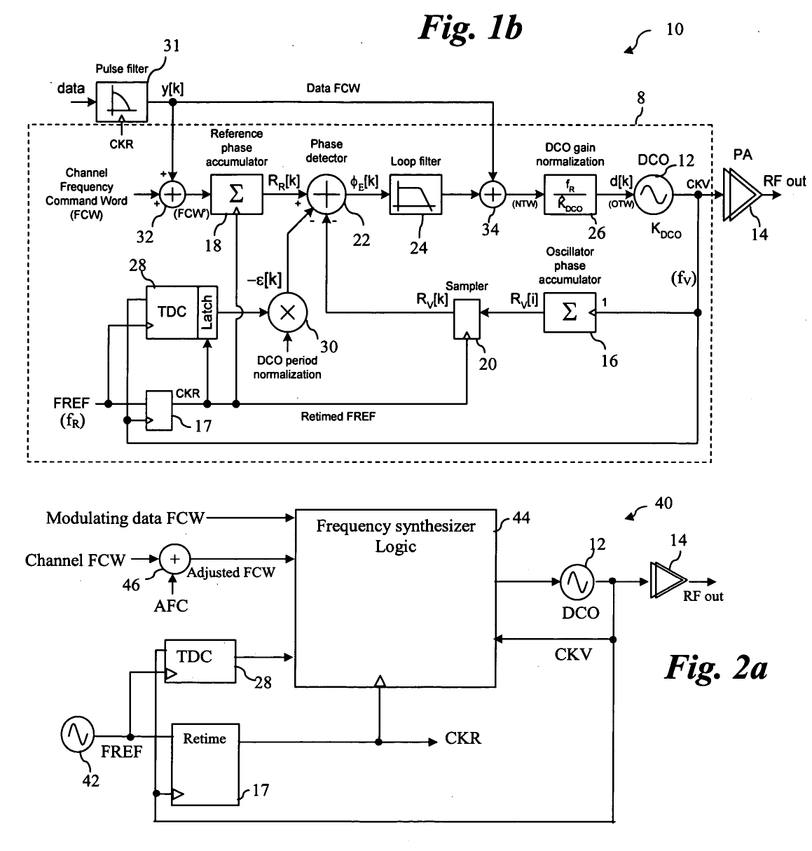

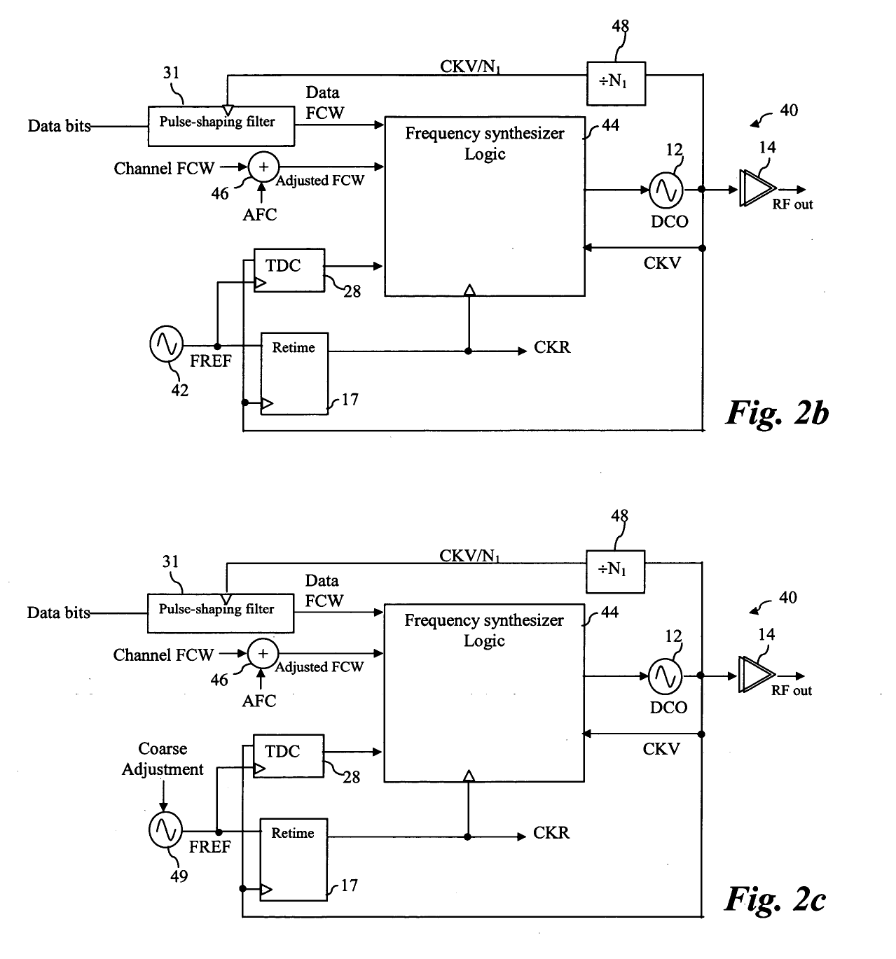

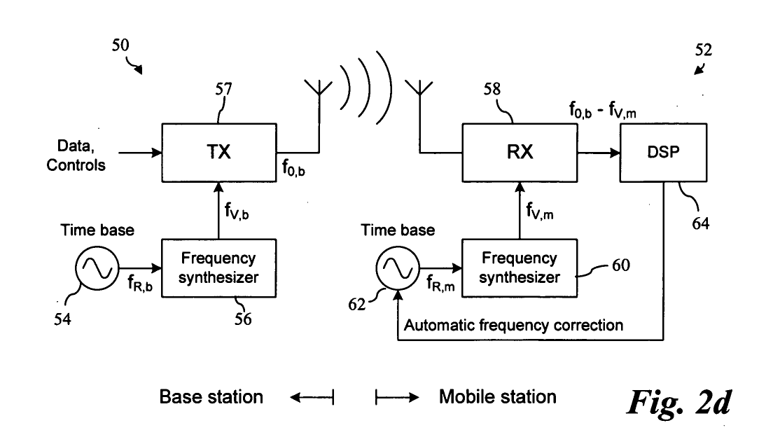

FIG. 2a illustrates an embodiment of the invention where a transmitter 40 uses a normal, free running, crystal oscillator 42 (or other time base which may vary from a predetermined frequency), without dedicated hardware (as in the case of a DCXO) which consumes a large silicon area. For purposes of illustration, pulse-shaping filter 31, adder 32, accumulator 18, phase detector 22, loop filter 24, adder 34, normalization circuit 26, latch 20, and accumulator 16 are merged into frequency synthesizer logic block 44. The channel FCW is added to an automatic frequency correction word (AFC) in adder 46.

The AFC word could be generated in a number of ways, depending upon the application. In a GSM application, where the basestation sends a reference frequency RF carrier signal, the device itself can determine the AFC (see FIG. 2d). Alternatively, where the basestation monitors the channel frequency of each mobile device, the basestation could send the AFC directly, or send timing information that can be used to determine the AFC. In either case, the AFC correction can be applied iteratively over a number of cycles.

Once the AFC is determined, its value is added to the channel FCW to generate an adjusted FCW which is lower in value (if the frequency of CKV, f_{V}, is above a desired frequency value), greater in value (if the frequency of CKV is below a desired frequency value), or the same (if the frequency of CKV is correct within a predetermined threshold). As f_{R} drifts, the AFC will change to compensate for the change in FREF; accordingly, FREF is allowed to run free without adjustment and deviations in f_{R} from a desired value are compensated by changing the adjusted FCW. In other words, deviations in FREF from a desired value are countered by changing the multiplication factor of the frequency synthesizer, not by stabilizing the reference frequency.

For small frequency deviations in FREF, the error in the modulating data rate and data FCW values are negligible, especially in a burst or packet transmit operation, such as in Bluetooth or GSM. However, for continuous transmit operations, such as in CDMA, both the data FCW and the data rates may need to be additionally corrected. In order to make the pulse shaping filter operating on the clock rate that is known and independent from the crystal oscillator frequency, it is proposed to operate the filter on the DCO divided clock, CKV/N₁. In this embodiment, advantage is taken of a prior adjustment of the carrier frequency by the AFC mechanism, as shown above.

FIG. 2b illustrates an embodiment of transmitter 40 for situations where FREF may vary enough to cause a significant deviation in the modulating data rate and data FCW values. A divided clock, CKVD, based on CKV (i.e., CKVD=CKV÷N₁; typically, N₁ would be a power of two) is generated by clock divider circuit 48. Pulse shaping filter 31 operates on CKVD, synchronous to the output of the DCO, rather than on a clock synchronous to FREF.

Alternatively, if the pulse-shaping filter operates on the CKR clock, then the data FCW samples should be corrected based on the accumulated timing deviation between the actual CKR timestamp and the ideal CKR or FREF timestamp.

FIG. 2c illustrates another embodiment using a local time base 49 which generates a signal FREF at a frequency that can be coarsely adjusted. For example, the frequency output of the time base 49 could be set using a 4-bit value which enables a combination of capacitors that controls the output of a crystal oscillator. It is assumed that the output of time base 49 will differ between devices an, hence f_{R} will vary as well. Accordingly, frequency adjustment is necessary. As described above, a difference between the reference frequency and a predetermined frequency can be compensated at RF by adjusting the value of the frequency command word, FCW.

While varying the output of a frequency synthesizer to compensate for variations in the output of a crystal oscillator is shown above in connection with a transmitter, the same principles could be applied to a receiver to generate a stable channel frequency for receiving data. However, due to a low intermediate frequency (IF) architecture, f_{V} could vary slightly from that shown above.

FIG. 2d illustrates an embodiment showing a typical frequency synchronization scenario between a base station 50 and a mobile station 52. Mobile station 52 could be a transceiver (such as a mobile communications device) or a receive-only device. The frequency reference of the base station f_{R,b} timebase 54 is considered precise since it is derived from an extremely accurate clock technology, such as a stratum-I or stratum-II atomic clock. A frequency synthesizer 56 in the base station creates an RF frequency f_{V,b}, which is used to generate a pure sine wave (PSR) RF signal at frequency f_{0,b}. This carrier frequency is transmitted by transmitter 57 either continuously or periodically at dedicated slots, such as a frequency correction channel (FCCH) in GSM.

In a wireless mobile station, the known PSR frequency is demodulated (frequency translated) by receive circuitry 58 to a low intermediate frequency (IF) f_{0,b}−f_{V,m}, where f_{V,m} is the mobile station local oscillator frequency generated by the frequency synthesizer 60 from the output of the time base 62. If f_{0,b}−f_{V,m} is non-zero (or outside a given threshold) or, alternatively, different from a predetermined frequency, the digital baseband (implemented in digital signal processor 64) can use a DSP algorithm to estimate the frequency and, thus, determine the automatic frequency correction to compensate for the frequency drift of the mobile station's time base generator 62. Since the frequency drift of the time base 62 is slow, the automatic frequency corrections (AFC) are done periodically.

As stated above, the reference clock retiming by the DCO clock strips FREF of its critical timing information and produces a retimed clock CKR that is subsequently used throughout the system. This ensures that the massive digital logic is clocked after the quiet interval of the phase error detection by the TDC 28. The CKR edge timestamps are synchronous to the RF oscillator, in which time separation between the closest CKR and CKV edges is time invariant. In this example, it is beneficial for avoiding injection pulling, in which the slowly varying timing separation between CKR and CKV causes the oscillator to be pulled, thus creating a frequency beating event that exhibits itself as spurs in the generated output.

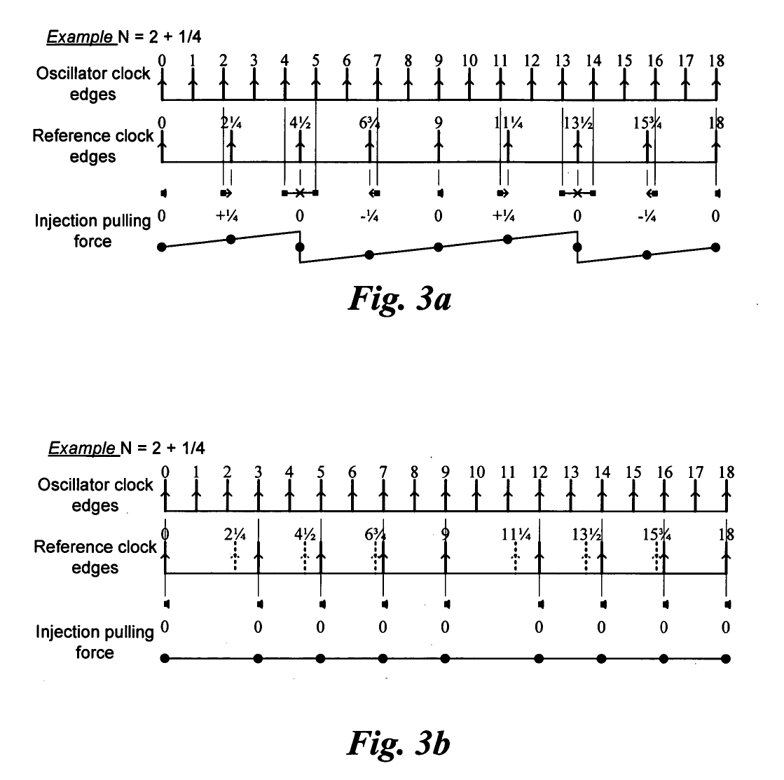

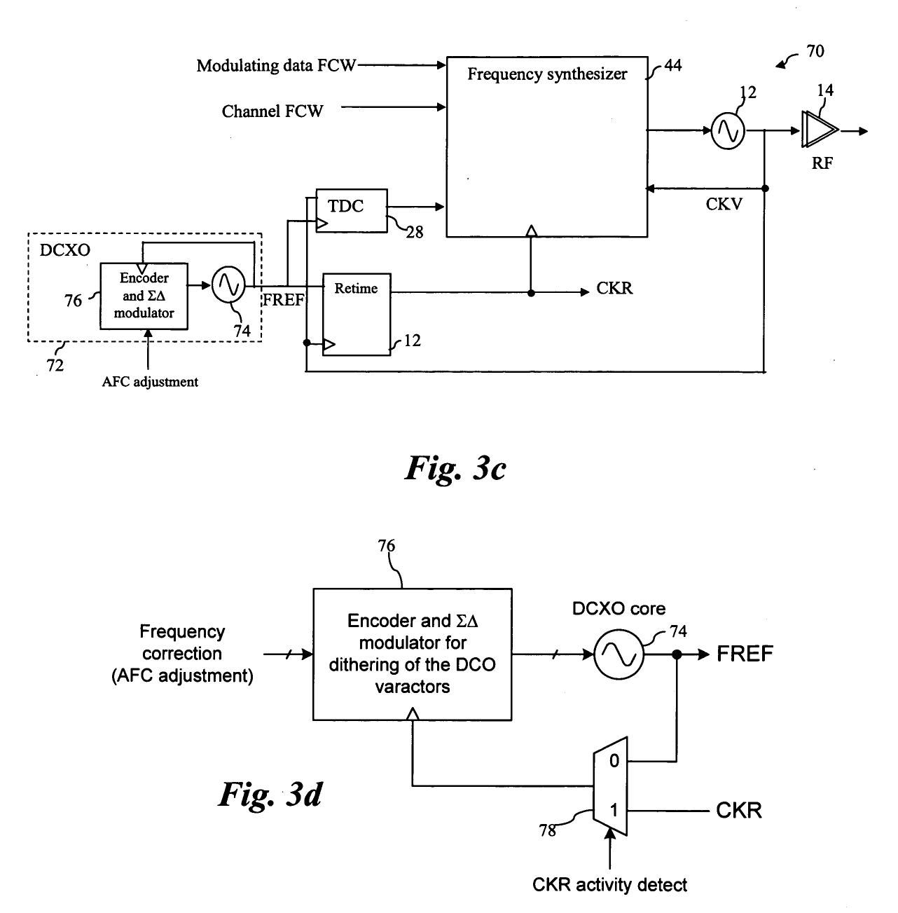

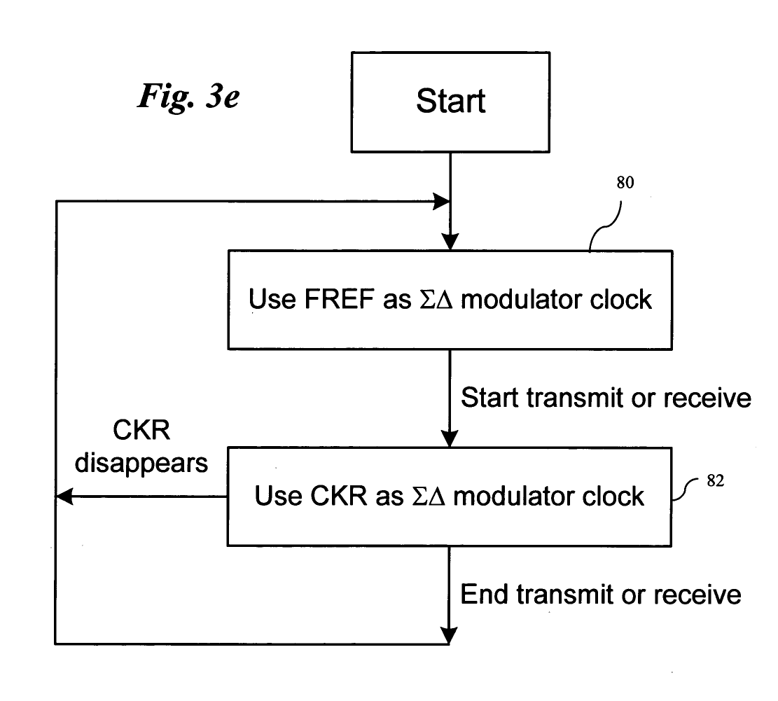

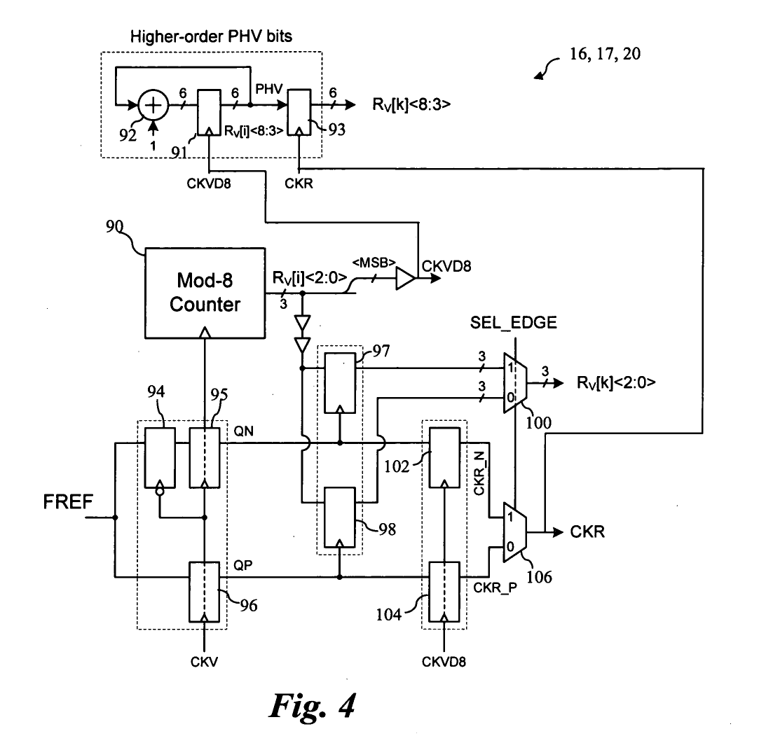

The injection pulling mechanism is revealed in FIG. 3a. It should be noted that the two frequencies need not to be close to each other. The injection pulling could be caused by a harmonic of the lower frequency FREF clock that falls in the frequency neighborhood of the oscillator. In the example, the interfering clock has a frequency 2.25 times lower than the oscillator frequency. Each of its edges pulls every second or third oscillator edge.

For a non-retimed FREF clock scenario, the injection pulling mechanism depends on the fractional part of the frequency division ratio N:
N═Nᵢ+N_{f}=f₀/f_{R}
where, Nᵢ and N_{f} are the integer and fractional parts of N, respectively. f₀ and f_{R} are the oscillator and the interfering FREF clock frequencies, respectively. If N_{f}=0, there is no injection pulling. If N_{f} is close to zero, it will give rise to a positive beating frequency f_{beat}=N_{f}×f_{R}. If N_{f} is close to one, it will give rise to a negative beating frequency f_{beat}=−(1−N_{f})×f_{R}. The terms “positive” and “negative” indicate here direction of change of the clock edge pulling force. The higher values of f_{beat} are generally not dangerous since they are likely to be too fast to coherently pull the oscillator.

The proposed FREF retiming method described above eliminates the effect of injection pulling, as shown in FIG. 3b. It should be noted that a constant non-zero pulling force would present no problem. In fact, due to different propagational delays of various interfering sources through power, ground and substrate paths, there will be a non-zero equilibrium state of the delays. It is important to realize that, as a result, the average frequencies of f₀ and f_{R} do not need an integer multiple ratio, i.e., N_{f}=0. The CKR clock described above has the same average frequency as FREF. The retiming operation only shifts the edges, but their expected averaged distances do not get affected.

FIG. 3c illustrates an embodiment of a transmitter 70 which uses a digitally controlled crystal oscillator (DCXO) 72 to generate the FREF signal. The DCXO 72 uses its own clock (FREF) to control and perform ΣΔ dithering of the varactors in the DCXO core (see FIG. 3d) responsive to an AFC adjustment to encoder and ΣΔ modulator logic 76. Hence, in this embodiment, variations in the frequency of FREF are corrected by an AFC to the DCXO. However, since the DCXO uses its own clock, it is susceptible to injection pulling, as described above.

FIG. 3d shows a block diagram of a (DCXO) with ΣΔ dithering for improving frequency resolution. In this embodiment, the digital logic 76 for encoding and ΣΔ dithering is clocked not on the FREF clock but on the retimed version CKR. This way, the amount of circuitry truly operating at FREF equidistant edges will be minimized. To avoid a “bootstrapping” problem, where CKR will not be available initially for clocking the digital logic 76, the digital logic 76 could initially operate on FREF and then switch to CKR once the retimed signal is stable.

FIG. 3e shows a flowchart of switching between the FREF and CKR clocks for the ΣΔ dithering. In step 80, FREF is used to clock the digital logic 76. Just prior to a transmit or receive period, in step 82, the multiplexer 78 switches to using CKR to clock the digital logic 76. At the end of the transmit or receive, or whenever CKR failure is detected (for example, by a watchdog circuit), the multiplexer should automatically switch to FREF.

U.S. Ser. No. 09/969,307, filed Oct. 2, 2001, entitled “Method and Apparatus For Asynchronous Clock Retiming” to Staszewski et al (Publication No. U.S. 2002/0131538 A1, dated Sep. 19, 2002), which is incorporated by reference herein, describes a retiming circuit, which could be used as retiming circuit 17 in the embodiment described herein. A SEL_EDGE signal from the TDC 28 selects the edge (rising or falling) that is least likely to cause metastability problems. The chief disadvantage of the method of retiming described in the aforementioned application is the need to delay both resampled candidates for the retimed clock CKR until the SEL_EDGE signal, from the TDC 28, is ready with a sufficiently low probability of metastability. This requires several delay stages operating at the RF rate.

FIG. 4 illustrates an improved retiming circuit 17. Advantage is taken here of the fact that the retimed reference clock CKR is absolutely needed only for precise sampling of the variable phase. All other circuits, which only require an approximate location of the CKR edges could use a “time-quantized” version of CKR. Consequently, arithmetic increment of lower-order <2:0> bits and FREF retiming is tightly coupled together into one block shown. The higher-order bits of <8:3> are calculated separately and latched with the quantized version of the CKR clock.

FIG. 4 combines the FREF retiming circuit 17, variable phase accumulator 16 and the variable phase sampler 10. A modulo-8 counter 90 (which could be implemented as a string of three divide-by-2 counters) is clocked at CKV. The output of modulo-8 counter 90 is the three least significant bits of the variable phase information, R_{V}[i]<2:0> (the variable phase data R_{V}[i] is output from accumulator 16 in FIG. 1b). Of these three bits, the most significant bit (R_{V}[i]<2>) is used as the CKVD8 clock (CKV divided by 8).

The higher order bits of the variable phase data (R_{V}[i]<8:3> are calculated by incrementing a value stored in latch 91 on each CKVD8 clock using incrementer 92. The higher order bits are sampled at the quantized version of the CKR clock in latch 93 to provide R_{V}[k]<8:3> (the output of sampler 20 in FIG. 1b).

The FREF reference is simultaneously sampled by the rising and falling edges of the CKV clock in latches 94, 95, and 96. Both versions of the retimed FREF reference at the output of latches 95 and 96 are used to sample the lower-order of the variable phase in latches 97 and 98, respectively. The selection signal, SEL_EDGE, chooses one of the two sampled PHV candidates at multiplexer 100. There is still the need to delay both retimed FREF candidates, but this is done with a down-divided CKV clock, i.e., CKVD8, at latches 102 and 104, thus saving power and area. Multiplexer 106 selects an output from latches 102 or 104 responsive to the SEL_EDGE signal to provide the quantized CKR clock.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the claims.

1. A receiver comprising:
a time base for generating a reference signal having a reference frequency;
a frequency multiplying circuit for generating an output signal having an output frequency responsive to the reference frequency and a digital frequency command word;
circuitry for adjusting the frequency command word responsive to a variation between the output frequency and a predetermined frequency.

2. The receiver of claim 1 wherein the circuitry for adjusting the frequency command word comprises circuitry for adding a predetermined frequency command word to a variable frequency command word.

3. The receiver of claim 2 wherein the receiver is in communication with a base station, and the base station provides data to generate the variable frequency command word.

4. The receiver of claim 2 wherein the receiver is in communication with a base station and receives a base station reference frequency signal and generates the variable frequency command word responsive to a comparison between the output frequency and the base station reference frequency.

5. The receiver of claim 1 wherein the frequency multiplying circuit comprises a phase locked loop circuit.

6. The receiver of claim 1 wherein the time base comprises a crystal oscillator.

7. The receiver of claim 1 wherein the time base further comprises circuitry for controlling the value of the reference frequency, such that the reference frequency can be set to a rough approximation of a desired reference frequency.

8. A transmitter comprising:
a time base for generating a reference signal having a reference frequency;
a frequency multiplying circuit for generating an output signal having an output frequency responsive to the reference frequency and a digital frequency command word;
circuitry for adjusting the frequency command word responsive to a variation between the output frequency and a predetermined frequency.

9. The transmitter of claim 8 and further comprising a pulse-shaping filter for generating data values for modulation on the output signal, wherein said pulse shaping filter is clocked synchronously with the output signal.

10. The transmitter of claim 9 and further comprising a frequency divider circuit for dividing the frequency of the output signal by a predetermined divisor.

11. A method of generating an output signal having a predetermined frequency, comprising the steps of:
generating a reference signal having a reference frequency in a time base;
generating an output signal having an output frequency responsive to the reference frequency and a digital frequency command word;
adjusting the frequency command word responsive to a variation between the output frequency and a predetermined frequency.

12. The method of claim 11 wherein said adjusting step comprises the step of adjusting the frequency command word to compensate for variations between the reference frequency and a specified frequency for the time base.

13. The method of claim 12 wherein the step of generating a reference signal comprises the step of setting the time base to a coarse approximation of a desired frequency.

14. The method of claim 11 wherein the step of adjusting the frequency command word comprises the step of adding a predetermined frequency command word to a variable frequency command word.

15. The method of claim 14 and further comprising the step of receiving data from a base station to generate the variable frequency command word.

16. The method of claim of claim 14 and further comprising the steps of:
receiving a base station reference frequency signal from a base station; and
generating the variable frequency command word responsive to a comparison between the output frequency and the base station reference frequency.

17. The method of claim 11 wherein the step of generating the output signal comprises the step of generating the output frequency in a phase locked loop circuit responsive to the reference frequency and a digital frequency command word.

18. The method of claim 11 and further comprising the steps of:
generating data values for modulation on the output signal in pulse-shaping filter; and
clocking the pulse-shaping filter synchronously with the output signal.

19. A receiver comprising:
a time base for generating a reference signal having a reference frequency;
control circuitry for controlling the reference frequency of the time base responsive to a frequency correction signal;
a digitally controlled frequency synthesizer for generating an output signal with an output frequency at a multiple of the reference frequency;
circuitry for clocking the control circuitry synchronously with edges of the output signal.

20. The receiver of claim 19 wherein the clocking circuitry comprises circuitry for clocking the control circuitry with edges of the reference signal for a first period and clocking the control circuitry synchronously with edges of the output signal for a second period.

21. The receiver of claim 19 wherein said clocking circuitry comprises circuitry for clocking the control circuitry synchronously with edges of the reference signal whenever the output signal is not stable.

22. The receiver of claim 19 wherein said clocking circuitry comprises circuitry for clocking the control circuitry with the reference signal retimed to an edge of the output signal.

23. A transmitter comprising:
a time base for generating a reference signal having a reference frequency;
control circuitry for controlling the reference frequency of the time base responsive to a frequency correction signal;
a frequency synthesizer for generating an output signal with an output frequency at a multiple of the reference frequency;
circuitry for clocking the control circuitry synchronously with edges of the output signal.

24. The transmitter of claim 23 wherein the clocking circuitry comprises circuitry for clocking the control circuitry synchronously with edges of the reference signal for a first period and clocking the control circuitry synchronously with edges of the output signal for a second period.

25. The transmitter of claim 23 wherein said clocking circuitry comprises circuitry for clocking the control circuitry synchronously with edges of the reference signal whenever the output signal is not stable.

26. The transmitter of claim 23 wherein said clocking circuitry comprises circuitry for clocking the control circuitry with the reference signal retimed to an edge of the output signal.

27. A method of generating an output signal having a predetermined frequency, comprising the steps of
generating a reference signal having a reference frequency in a time base;
controlling the reference frequency of the time base with a control circuit responsive to a frequency correction signal;
generating an output signal with an output frequency at a multiple of the reference frequency in a frequency synthesizer;
clocking the control circuit synchronously with edges of the output signal.

28. The method of claim 27 wherein the clocking step comprises the step of clocking the control circuit synchronously with edges of the reference signal for a first period and clocking the control circuit synchronously with edges of the output signal for a-second period.

29. The method of claim 27 wherein said clocking step comprises the step of clocking the control circuit synchronously with edges of the reference signal whenever the output signal is not stable.

30. The method of claim 27 wherein said clocking step comprises the step of clocking the control circuit with the reference signal retimed to an edge of the output signal.

31. A phase locked loop circuit comprising:
circuitry for generating an output signal at a frequency multiple of a reference signal, responsive in part to variable phase information associated with a difference between edges of the reference signal and edges of the output signal;
circuitry for sampling the reference signal on both rising and falling edges of the output signal to produce first and second retimed reference signals;
circuitry for selecting from either the first or second retimed reference signal responsive to a metastability control signal;
circuitry for sampling low-order variable phase information on both the first and second retimed reference signals to produce first and second variable phase samples;
circuitry for selecting from either the first or second variable phase samples responsive to a metastability control signal;
circuitry for sampling higher-order variable phase information responsive to the selected retimed reference signal.

32. The phase locked loop circuit of claim 31 wherein said higher order variable phase information is generated by incrementing a value responsive to a most significant bit of the low-order variable phase information.

33. A method of generating an output signal as a frequency multiple of a reference signal, responsive in part to variable phase information associated with a difference between edges of the reference signal and edges of the output signal, comprising the steps of:
sampling the reference signal on both rising and falling edges of the output signal to produce first and second retimed reference signals;
selecting from either the first or second retimed reference signal responsive to a metastability control signal;
sampling low-order variable phase information on both first and second retimed reference signals to produce first and second variable phase samples;
selecting from either the first or second variable phase samples responsive to a metastability control signal;
sampling higher-order variable phase information responsive to the selected retimed reference signal.

34. The method of claim 33 wherein said higher order variable phase information is generated by incrementing a value responsive to a most significant bit of the low-order variable phase information.
